(19) United States
(12) Patent Application Publication
(10) Pub. No.: US 2020/0041276 A1
(43) Pub. Date: Feb. 6, 2020

(54) End-To-End Deep Generative Model For Simultaneous Localization And Mapping

(71) Applicant: Ford Global Technologies, LLC, Dearborn, MI (US)

(72) Inventors: Punarjay Chakravarty, Mountain View, CA (US); Praveen Narayanan, San Jose, CA (US)

(21) Appl. No.: 16/054,694

(22) Filed: Aug. 3, 2018

(51) Int. Cl. G01C 21/32; G06F 17/30; G06N 3/08; G06N 3/04; G06T 7/73

(52) U.S. Cl. CPC G01C 21/32; G06F 17/30241; G06N 3/088; G06N 3/0454; G06T 2207/20084; G06T 2207/10028; G06T 2207/30252; G06T 2207/20081; G06T 7/74

(57) ABSTRACT

The disclosure relates to systems, methods, and devices for simultaneous localization and mapping of a robot in an environment utilizing a variational autoencoder generative adversarial network (VAE-GAN). A method includes receiving an image from a camera of a vehicle and providing the image to a VAE-GAN. The method includes receiving from the VAE-GAN reconstructed pose vector data and a reconstructed depth map based on the image. The method includes calculating simultaneous localization and mapping for the vehicle based on the reconstructed pose vector data and the reconstructed depth map. The method is such that the VAE-GAN comprises a latent space for receiving a plurality of inputs.

### TECHNICAL FIELD

The present disclosure relates to methods, systems, and apparatuses for simultaneous localization and mapping of an apparatus in an environment, and particularly relates to simultaneous localization and mapping of a vehicle using a variational autoencoder generative adversarial network.

### BACKGROUND

Localization, mapping, and depth perception in real-time are requirements for certain autonomous systems, including autonomous driving systems or mobile robotics systems. Each of localization, mapping, and depth perception are key components for carrying out certain tasks such as obstacle avoidance, route planning, mapping, localization, pedestrian detection, and human-robot interaction. Depth perception and localization are traditionally performed by expensive active sensing systems such as LIDAR sensors or passive sensing systems such as binocular vision or stereo cameras.

Systems, methods, and devices for computing localization, mapping, and depth perception can be integrated in automobiles such as autonomous vehicles and driving assistance systems. Such systems are currently being developed and deployed to provide safety features, reduce an amount of user input required, or even eliminate user involvement entirely. For example, some driving assistance systems, such as crash avoidance systems, may monitor driving, positions, and a velocity of the vehicle and other objects while a human is driving. When the system detects that a crash or impact is imminent the crash avoidance system may intervene and apply a brake, steer the vehicle, or perform other avoidance or safety maneuvers. As another example, autonomous vehicles may drive, navigate, and/or park a vehicle with little or no user input. However, due to the dangers involved in driving and the costs of vehicles, it is extremely important that autonomous vehicles and driving assistance systems operate safely and are able to accurately navigate roads in a variety of different driving environments.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an example vehicle control system or autonomous vehicle system, according to one embodiment;

FIG. 2 is a schematic block diagram of a variational autoencoder generative adversarial network in a training phase, according to one embodiment;

FIG. 3 is a schematic block diagram of a variational autoencoder generative adversarial network in a computation phase, according to one embodiment;

FIG. 4 is a schematic block diagram illustrating a process for determining a depth map of an environment, according to one embodiment;

FIG. 5 is a schematic flow chart diagram of a method for utilizing simultaneous localization and mapping of a vehicle in an environment, according to one embodiment;

FIG. 6 is a schematic flow chart diagram of a method for utilizing simultaneous localization and mapping of a vehicle in an environment, according to one embodiment;

FIG. 7 is a schematic flow chart diagram of a method for training a variational autoencoder generative adversarial network, according to one embodiment; and

FIG. 8 is a schematic block diagram illustrating an example computing system, according to one embodiment.

### DETAILED DESCRIPTION

Localization of a vehicle along with mapping and depth perception of drivable surfaces or regions is an important aspect of allowing for and improving operation of autonomous vehicle or driver assistance features. For example, a vehicle must know precisely where obstacles or drivable surfaces are located to navigate safely around objects.

Simultaneous Localization and Mapping (SLAM) forms the basis for operational functionality of mobile robots, including autonomous vehicles and other mobile robots. Examples of such robots include an indoor mobile robot configured for delivering items in a warehouse or an autonomous drone configured for traversing a building or other environment in a disaster scenario. SLAM is directed to sensing the robot's environment and building a map of its surroundings as the robot moves through its environment. SLAM is further directed to simultaneously localizing the robot within its environment by extracting pose vector data, including six Degree of Freedom (DoF) poses relative to a starting point of the robot. SLAM thus incrementally generates a map of the robot's environment. In the case of a robot repeating a route that it has previously mapped, the robot can solve for the localization subset of the problem without generating a new map. The generating of building a map of a new area necessitates SLAM.

SLAM is commonly implemented utilizing a depth sensor, such as a LIDAR sensor or a stereo camera. SLAM normally necessitates such devices for enabling the SLAM process to measure the depth and distance of three-dimensional landmarks and to calculate the robot's position in relation to those landmarks. SLAM may also be implemented using monocular vision, but the depth recovered through triangulation of landmarks from a moving camera over time is up to scale only, such that relative depths of objects in the scene are recovered without absolute depth measurements.

Applicant recognizes than allied problem in robots is one of obstacle avoidance. Robots must know how far an object is from the robot such that the robot can determine a collision-free path around the object. Robots utilize LIDAR sensors and stereo camera to determine a dense depth-map of obstacles around the robot. Some of the same obstacles determined through this process may be utilized as three-dimensional landmarks in the SLAM implementation.

Applicant has developed systems, methods, and devices for improving operations in both SLAM and obstacle avoidance. Applicant presents systems, methods, and devices for generating a dense depth map for obstacle avoidance, determining a robot's location, and determining pose vector data as a robot traverses its environment. The systems, methods, and devices of the present disclosure utilize a monocular camera and do not necessitate the use of expensive LIDAR sensors or stereo cameras that further require intensive computing resources. The disclosure presents lightweight, inexpensive, and low-computing methods for sensing a robot's surrounding, localizing a robot within its environment, and enabling the robot to generate obstacle avoidance movement procedures. Such systems, methods, and devices of the present disclosure may be implemented on any suitable robotics system, including for example, an autonomous vehicle, a mobile robot, and/or a drone or smart mobility vehicle.

Variational autoencoders (VAEs) are a class of latent variable models that provide compressed latent representations of data. A VAE can serve as an autoencoder while further serving as a generative model from which new data can be generated by sampling from a latent manifold. The VAE consists of an encoder, which maps the input to a compressed latent representation. The VAE further includes a decoder configured to decode the latent vector back to an output. The entire VAE system may be trained end to end as a deep neural network.

The VAE may be configured to encode meaningful information about various data attributes in its latent manifold which can then be exploited to carry out pertinent tasks. In an implementation of the disclosure, Applicant presents utilizing a shared latent space assumption of a VAE between an image, pose vector data of the image, and a depth map of the image, to facilitate the use of SLAM in conjunction with the VAE.

Generative adversarial networks (GANs) are a class of generative models configured to produce high quality samples from probability distributions of interest. In the image domain, a GAN may generate output samples of stellar artistic quality. The training methodology for a GAN is adversarial, in that the generator (the network that produces samples, often called “fakes”) learns by fooling another network called the discriminator that decides whether the samples produced are real or fake. The generator network and the discriminator network are trained in tandem, with the generator network eventually learning to produce samples that succeed in fooling the discriminator network. At such a point, the GAN is able to generate samples from the probability distribution underlying the generative process.

Applicant recognizes that VAEs confer advantages in providing latent representations of data for further us. However, one drawback of the VAE is the blurriness of the samples produced. GANs, on the other hand, produce excellent samples but do not have a useful latent representation available. The variational autoencoder generative adversarial network (VAE-GAN) utilizes and combines each system such that one obtains a tractable VAE latent representation while also improving upon the quality of the samples by using a GAN as the generator in the decoder of the VAE. This results in crisper images than a VAE alone.

The systems, methods, and devices of the present disclosure utilize the VAE-GAN as the central machinery in the SLAM algorithm. Such systems, methods, and devices receiving an input such as a red-green-blue (RGB) image and outputs corresponding depth maps and pose vector data for the camera that captured the RGB image. The system is trained using a regular stereo visual SLAM pipeline, where stereo visual simultaneous localization and mapping (vSLAM) receives a sequence of stereoscopic images, generates the depth maps and corresponding six Degree of Freedom poses as the stereo camera moves through space. Stereo vSLAM trains the VAE-GAN-SLAM algorithm using a sequence of RGB images, the corresponding depth maps for the images, and the corresponding pose vector data for the images. The VAE-GAN is trained to reconstruct the RGB image, the pose vector data for the image, and the depth map for the image while creating a shared latent space representation of the same. The assumption is that the RGB image, depth map of the image, and pose vector data of the image are sampled from places close together in the real world, are close together in the learnt shared latent space as well. After the networks are trained, the VAE-GAN take as its input an RGB image coming from a monocular camera moving through the same environment and produce both a depth map and pose vector data for the monocular camera.

In an embodiment, the latent space representation of the VAE-GAN also enables disentanglement and latent space arithmetic. An example of such an embodiment would be to isolate a dimension in the latent vector responsible for a certain attribute of interest, such as a pose dimension, and create previously unseen view of a scene by changing the pose vector.

Applicant recognizes that the systems, methods, and devices disclosed herein enable the use of the system as a SLAM box for facilitating fast and easy single-image inference producing the pose of a robot and the positions of obstacles in the environment around the robot.

Generative adversarial networks (GANs) have shown that image-to-image transformation, for instance segmentation or labelling tasks, can be achieved with smaller amounts of training data compared to regular convolutional neural networks by training generative networks and discriminative networks in an adversarial manner. Applicant presents systems, methods, and devices for depth estimation of a single image using a GAN. Such systems, methods, and devices improve performance over known depth estimation systems, and further require a smaller number of training images. The use of GAN as opposed to a regular convolutional neural network enables the collection of a small amount of training data in each environment, typically in the hundreds of images as opposed to the hundreds of thousands of images required by convolutional neural networks. Such systems, methods, and devices reduce the burden for data collection by an order of magnitude.

Applicant further presents systems, methods, and devices for depth estimation utilizing visual simultaneous localization and mapping (vSLAM) methods for ensuring temporal consistency in the generated depth maps produced by the GAN as the camera moves through an environment. The vSLAM module provides pose information of the camera, e.g. how much the camera has moved between successive images. Such pose information is provided to the GAN as a temporal constraint on training the GAN to promote the GAN to generate consistent depth maps for successive images.

Before the methods, systems, and devices for determining simultaneous localization and mapping for a robot are disclosed and described, it is to be understood that this disclosure is not limited to the configurations, process steps, and materials disclosed herein as such configurations, process steps, and materials may vary somewhat. It is also to be understood that the terminology employed herein is used for describing implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

In one embodiment, a method for mapping and localizing a robot, such as an autonomous vehicle, in an environment is disclosed. The method includes receiving an image from a camera of a vehicle. The method includes providing the image to a variational autoencoder generative adversarial network (VAE-GAN). The method includes receiving from the VAE-GAN reconstructed pose vector data and a reconstructed depth map based on the image. The method includes calculating simultaneous localization and mapping for the vehicle based on the reconstructed pose vector data and the reconstructed depth map. The method is such that the VAE-GAN comprises a single latent space for encoding a plurality of inputs.

Further embodiments and examples will be discussed in relation to the figures below.

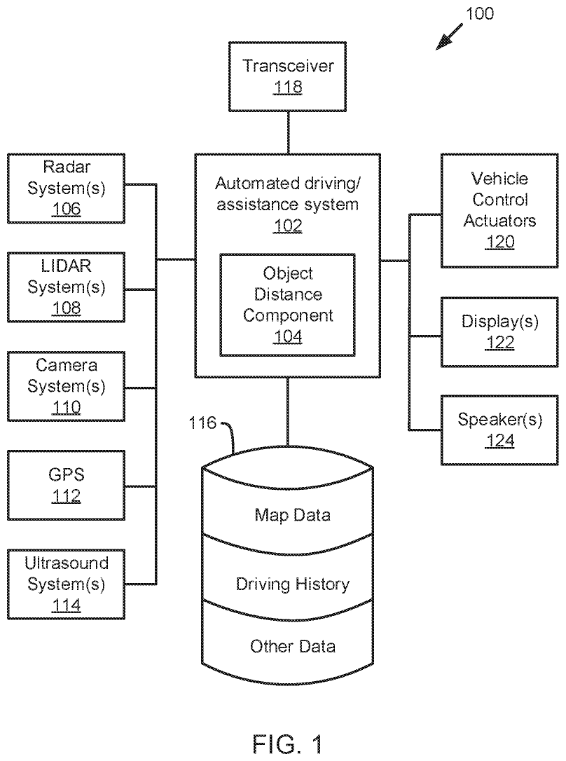

Referring now to the figures, FIG. 1 illustrates an example vehicle control system 100 that may be used for autonomous or assisted driving. The automated driving/assistance system 102 may be used to automate or control operation of a vehicle or to aid a human driver. For example, the automated driving/assistance system 102 may control one or more of braking, steering, acceleration, lights, alerts, driver notifications, radio, or any other auxiliary systems of the vehicle. In another example, the automated driving/assistance system 102 may not be able to provide any control of the driving (e.g., steering, acceleration, or braking), but may provide notifications and alerts to assist a human driver in driving safely. The automated driving/assistance system 102 may use a neural network, or other model or algorithm to detect or localize objects based on perception data gathered by one or more sensors.

The vehicle control system 100 also includes one or more sensor systems/devices for detecting a presence of objects near or within a sensor range of a parent vehicle (e.g., a vehicle that includes the vehicle control system 100). For example, the vehicle control system 100 may include one or more radar systems 106, one or more LIDAR systems 108, one or more camera systems 110, a global positioning system (GPS) 112, and/or one or more ultrasound systems 114. The vehicle control system 100 may include a data store 116 for storing relevant or useful data for navigation and safety such as map data, driving history or other data. The vehicle control system 100 may also include a transceiver 118 for wireless communication with a mobile or wireless network, other vehicles, infrastructure, or any other communication system.

The vehicle control system 100 may include vehicle control actuators 120 to control various aspects of the driving of the vehicle such as electric motors, switches or other actuators, to control braking, acceleration, steering or the like. The vehicle control system 100 may also include one or more displays 122, speakers 124, or other devices so that notifications to a human driver or passenger may be provided. A display 122 may include a heads-up display, dashboard display or indicator, a display screen, or any other visual indicator which may be seen by a driver or passenger of a vehicle. A heads-up display may be used to provide notifications or indicate locations of detected objects or overlay instructions or driving maneuvers for assisting a driver. The speakers 124 may include one or more speakers of a sound system of a vehicle or may include a speaker dedicated to driver notification.

It will be appreciated that the embodiment of FIG. 1 is given by way of example only. Other embodiments may include fewer or additional components without departing from the scope of the disclosure. Additionally, illustrated components may be combined or included within other components without limitation.

In one embodiment, the automated driving/assistance system 102 is configured to control driving or navigation of a parent vehicle. For example, the automated driving/assistance system 102 may control the vehicle control actuators 120 to drive a path on a road, parking lot, driveway or other location. For example, the automated driving/assistance system 102 may determine a path based on information or perception data provided by any of the components 106-114. The sensor systems/devices 106-114 may be used to obtain real-time sensor data so that the automated driving/assistance system 102 can assist a driver or drive a vehicle in real-time.

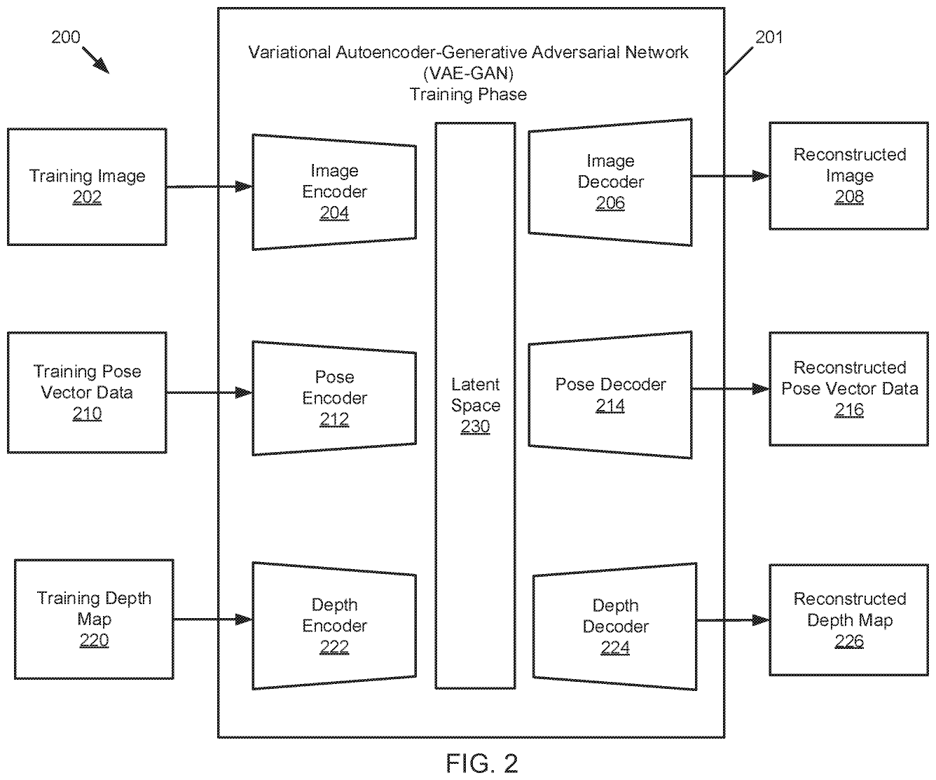

FIG. 2 illustrates a schematic block diagram of a training phase 200 of a variational autoencoder generative adversarial network (VAE-GAN) 201. The VAE-GAN 201 includes an image encoder 204 and a corresponding image decoder 206. The VAE-GAN 201 includes a pose encoder 212 and a corresponding pose decoder 214. The VAE-GAN 201 includes a depth encoder 222 and a corresponding depth decoder 224. Each of the image decoder 206, the pose decoder 214, and the depth decoder 224 includes a generative adversarial network (GAN) that comprises a GAN generator (see e.g. 404) and a GAN discriminator (see e.g. 408). The VAE-GAN 201 includes a latent space 230 that is shared by each of the image encoder 204, the image decoder 206, the pose encoder 212, the pose decoder 214, the depth encoder 222, and the depth decoder 224. The VAE-GAN 201 receives a training image 202 at the image encoder 204 and generates a reconstructed image 208 based on the training image 202. The VAE-GAN 201 receives training pose vector data 210 that is based on the training image 202 at the pose encoder 212 and the VAE-GAN 201 generates reconstructed pose vector data 216 based on the training pose vector data 210. The VAE-GAN 201 receives a training depth map 220 that is based on the training image 202 at the depth encoder 222 and outputs a reconstructed depth map 226 that is based on the training depth map 220.

The VAE-GAN 201 is the central machinery in the simultaneous localization and mapping (SLAM) algorithm of the present disclosure. In an embodiment the VAE-GAN 201 is trained utilizing a regular stereo visual SLAM pipeline. In such an embodiment, a stereo visual SLAM takes a sequence of stereoscopic images and generates depth maps and corresponding six Degrees of Freedom poses for the stereo camera as the camera moves through space. Stereo visual SLAM trains the VAE-GAN-SLAM algorithm using a sequence of red-green-blue (RGB) images where only the left image of a stereo pair is used, along with the corresponding depth maps and six Degrees of Freedom pose vector data for the sequence of RGB images. The VAE-GAN 201 is trained under the assumption that the RGB image, the depth map of the image, and the pose vector data of the image are sampled from locations close together in the real world that are also close together in the learnt shared latent space 230 as well. After the networks are trained, the VAE-GAN 201 can take as its input an RGB image coming from a monocular camera moving through the same environment and produce both a depth map and a six Degree of Freedom pose vector data for the camera.

The training image 202 is provided to the VAE-GAN 201 for training the VAE-GAN 201 to generate pose vector data and/or depth map data based on an image. In an embodiment the training image 202 is a red-blue-green (RGB) image captured by a monocular camera. In an embodiment the training image 202 is a single image of a stereo image pair captured by a stereo camera. The reconstructed image 208 is generated by the VAE-GAN 201 based on the training image 202. The image encoder 204 and the image decoder 206 are adversarial to one another and are configured to generate the reconstructed image 208. The image encoder 204 is configured to receiving the training image 202 and map the training image 202 to a compress latent representation in the latent space 230. The image decoder 206 comprises a GAN having a GAN generator and a GAN discriminator. The image decoder 206 is configured to decode the compressed latent representation of the training image 202 from the latent space 230. The GAN of the image decoder 206 is configured to generate the reconstructed image 208.

The training pose vector data 210 is provided to the VAE-GAN 201 for training the VAE-GAN 201 to generate pose vector data of an image. In an embodiment, the training pose vector data 210 includes six Degree of Freedom pose data of a camera that captured the training image 202, wherein the six Degree of Freedom pose data indicates a relative pose of the camera when the image was captured as the camera traversed an environment. The reconstructed pose vector data 216 is generated by the VAE-GAN 201 based on the training pose vector data 210. The pose encoder 212 is configured to receive the training pose vector data 210 and map the training pose vector data 210 to a compressed latent representation in the latent space 230 of the VEA-GAN 201. The pose decoder 214 is configured to decode the compressed latent representation of the training pose vector data 210 from the latent space 230. The pose decoder 214 comprises a GAN that comprises a GAN generator and a GAN discriminator. The GAN of the pose decoder 214 is configured to generate the reconstructed pose vector data 216 based on the training pose vector data 210.

The training depth map 220 is provided to the VAE-GAN 201 for training the VAE-GAN 201 to generate a depth map of an image. In an embodiment, the depth map 220 is based on the training image 202 and includes depth information for the training image 202. The reconstructed depth map 226 is generated by the VAE-GAN 201 based on the training depth map 220. The depth encoder 222 is configured to receive the training depth map 220 and map the training depth map 220 to a compressed latent representation in the latent space 230 of the VAE-GAN 201. The depth decoder 224 comprises a GAN that comprises a GAN generator and a GAN discriminator. The depth decoder 224 is configured to decode the compressed latent representation of the training depth map 220 from the latent space 230. The GAN of the depth decoder 224 is configured to generate the reconstructed depth map 226 based on the training depth map 220.

The latent space 230 of the VAE-GAN 201 is shared by each of the image encoder 204, the image decoder 206, the pose encoder 212, the pose decoder 214, the depth encoder 222, and the depth decoder 224. Thus, the VAE-GAN 201 is trained to generate each of the reconstructed image 208, the reconstructed pose vector data 216, and the reconstructed depth map 226 in tandem. In an embodiment, the latent space 230 includes an encoded latent space vector applicable to each of an image, pose vector data of an image, and a depth map of an image. The latent space 230 representation of the VAE-GAN 201 enables disentanglement and latent space arithmetic. An example of the disentanglement and latent space arithmetic includes isolating a dimension in the latent space 230 responsible for a certain attribute of interest, such as a posed dimension. This may enable the creation of a previously unseen view of a scheme by changing the pose vector. In an embodiment, training the latent space 230 simultaneously for all three attributes, namely the image, the pose vector data, and the depth map, forces the latent space 230 to be consistent for each of the attributes. This provides an elegant formulation where the VAE-GAN 201 is not trained separately for each of an image, pose vector data, and a depth map. Thus, because the VAE-GAN 201 is trained in tandem, the trained VAE-GAN 201 may receive an input image and generate any outer output such as pose vector data based on the input image or a depth map based on the input image.

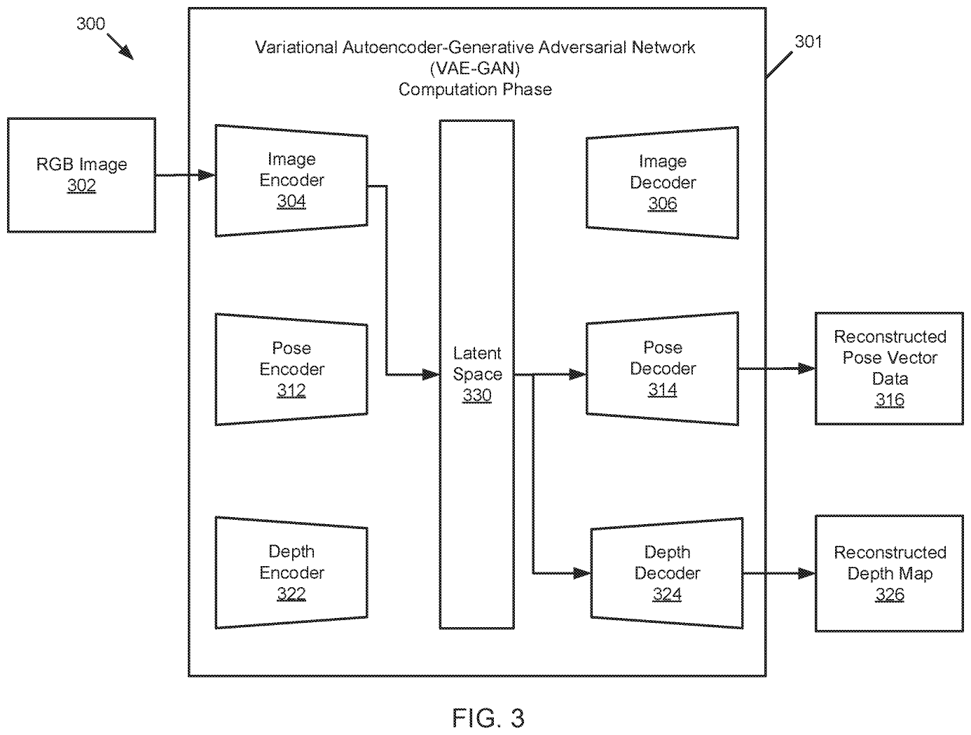

FIG. 3 illustrates a schematic block diagram of a computing phase 300 (alternatively may be referred to as a generative or execution phase) of a variational autoencoder generative adversarial network (VAE-GAN) 301. The VAE-GAN 301 includes an image encoder 304 and a corresponding image decoder 306, wherein the image decoder 306 comprises a GAN configured to generate a reconstructed image based on the RGB image 302. In an embodiment as illustrated in FIG. 3, the image encoder 304 and the image decoder 306 have been trained (see FIG. 2). The VAE-GAN 301 includes a pose encoder 312 and a corresponding pose decoder 314, wherein the pose decoder 314 comprises a GAN configured to generate the reconstructed pose vector data 316 based on the RGB image 302. In an embodiment as illustrated in FIG. 3, the pose encoder 312 and the pose decoder 314 have been trained (see FIG. 2). The VAE-GAN 301 includes a depth encoder 322 and a corresponding depth decoder 324, wherein the depth decoder 324 comprises a GAN configured to generate the reconstructed depth map 326 based on the RGB image 302. In an embodiment as illustrated in FIG. 3, the depth encoder 322 and the depth decoder 324 have been trained (see FIG. 2). The VAE-GAN 301 includes a latent space 330 that is shared by the image encoder 304, the image decoder 306, the pose encoder 312, the pose decoder 314, the depth encoder 322, and the depth decoder 324. The VAE-GAN 301 receives an RGB image 302 at the image encoder 304. The VAE-GAN outputs reconstructed pose vector data 316 at the trained pose decoder 314. The VAE-GAN outputs a reconstructed depth map 326 at the trained depth decoder 324.

In an embodiment the RGB image 302 is a red-green-blue image captured by a monocular camera and provided to the VAE-GAN 301 after the VAE-GAN 301 has been trained. In an embodiment, the RGB image 302 is captured by a monocular camera of a vehicle, is provided to a vehicle controller, and is provided to the VAE-GAN 301 in real-time. The RGB image 302 may provide a capture of an environment of the vehicle and may be utilized to determine depth perception for the vehicle surroundings. In such an embodiment the vehicle controller may implement the result of the VAE-GAN 301 into a SLAM algorithm for computing simultaneous localization and mapping of the vehicle in real-time. The vehicle controller may further provide a notification to a driver, determine a driving maneuver, or execute a driving maneuver based on the results of the SLAM algorithm.

The reconstructed pose vector data 316 is generated by a GAN embedded in the pose decoder 314 of the VAE-GAN 301. The VAE-GAN 301 may be trained to generate the reconstructed pose vector data 316 based on a monocular image. In an embodiment as illustrated in FIG. 3, the VAE-GAN 301 includes a latent space 330 that is shared by each of an image encoder/decoder, a pose encoder/decoder, and a depth encoder/decoder. The shared latent space 330 enables the VAE-GAN 301 to generate any trained output based on an RGB image 302 (or non-RGB image) as illustrated. The reconstructed pose vector data 316 includes six Degree of Freedom pose data for a monocular camera. The reconstructed pose vector data 316 may be utilized by a vehicle to determine a location of the vehicle in its environment and further utilized for simultaneous localization and mapping of the vehicle as it moves through space by implementing the data in a SLAM algorithm.

The reconstructed depth map 326 is generated by a GAN embedded in the depth decoder 324 of the VAE-GAN 301. The VAE-GAN 301 may be trained to generate the reconstructed depth map 326 based only on the RGB image 302. The reconstructed depth map 326 provides a dense depth map based on the RGB image 302 and may provide a dense depth map of a surrounding of a robot or autonomous vehicle. The reconstructed depth map 326 may be provided to a SLAM algorithm for calculating simultaneous localization and mapping of a robot as the robot moves through its environment. In an embodiment where the robot is an autonomous vehicle, a vehicle controller may then provide a notification to a driver, determine a driving maneuver, and/or execute a driving maneuver such as an obstacle avoidance maneuver based on the reconstructed depth map 326 and the result of the SLAM algorithm.

The latent space 330 is shared by each of the image encoder 304, the image decoder 306, the pose encoder 312, the pose decoder 314, the depth encoder 322, and the depth decoder 324. In an embodiment the latent space 330 comprises an encoded latent space vector that is utilized for each of an image, pose vector data of an image, and a depth map of an image. In such an embodiment, the VAE-GAN 301 is capable of determining any suitable output e.g. reconstructed pose vector data 316 and/or a reconstructed depth map 326 based on an RGB image 302 input. Each of the encoders, including the image encoder 304, the pose encoder 312, and the depth encoder 322 is configured to map an input into a compressed latent representation at the latent space 330. Conversely, each of the decoders, including the image decoder 306, the pose decoder 314, and the depth decoder 324 are configured to decode the compressed latent representation of the input from the latent space 330. The decoders of the VAE-GAN 301 further include a GAN that is configured to generate an output based on the decoded version of the input.

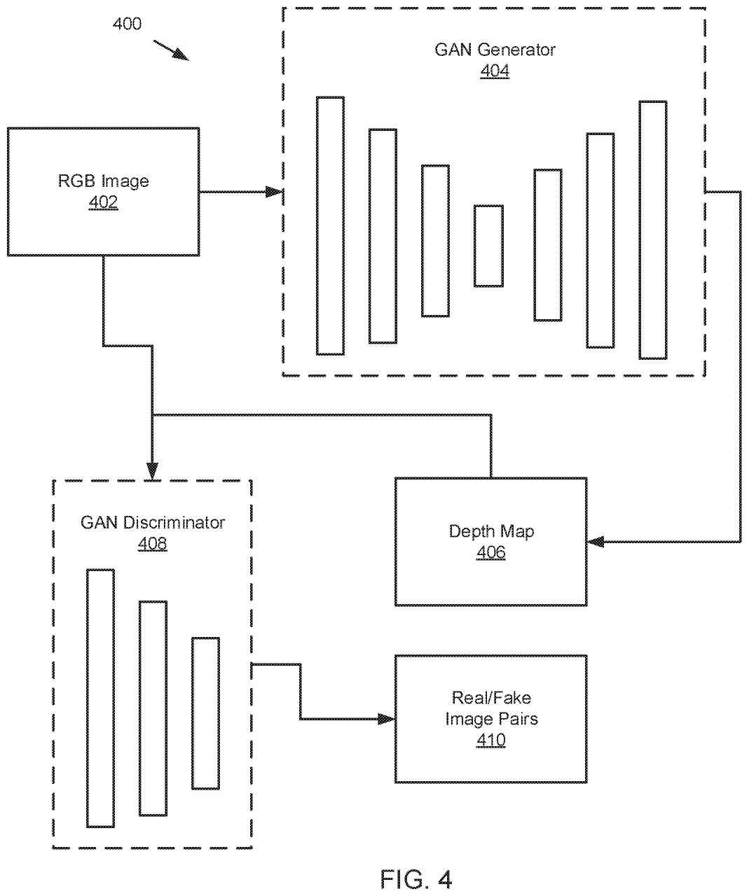

FIG. 4 illustrates a schematic block diagram of a process 400 of determining a depth map of an environment, according to one embodiment. In an embodiment the process 400 is implemented in a depth decoder 324 that comprises a GAN configured to generate a reconstructed depth map 326. It should be appreciated that a similar process 400 may be implemented in a pose decoder 314 that comprises a GAN that is configured to generate reconstructed pose vector data 316. The process 400 includes receiving an RGB image 402 and feeding the RGB image 402 to a generative adversarial network (hereinafter “GAN”) generator 404. The GAN generator 404 generates a depth map 406 based on the RGB image 402. A generative adversarial network (“GAN”) discriminator 408 receives the RGB image 402 (i.e. the original image) and the depth map 406 generated by the GAN generator 404. The GAN discriminator 408 is configured to distinguish real and fake image pairs 410, e.g. genuine images received from a camera versus depth map images generated by the GAN generator 404.

In an embodiment, the RGB image 402 is received from a monocular camera and may be received from the monocular camera in real-time. In an embodiment, the monocular camera is attached to a moving device, such as a vehicle, and each RGB image 402 is captured when the monocular camera is in a unique position or is in a unique pose. In an embodiment, the monocular camera is attached to an exterior of a vehicle and provides the RGB image 402 to a vehicle controller, and the vehicle controller is in communication with the GAN generator 404.

The GAN (i.e. the combination of the GAN generator 404 and the GAN discriminator 408) comprises a deep neural network architecture comprising two adversarial nets in a zero-sum game framework. In an embodiment, the GAN generator 404 is configured to generate new data instances and the GAN discriminator 408 is configured to evaluate the new data instances for authenticity. In such an embodiment, the GAN discriminator 408 is configured to analyze the new data instances and determine whether each new data instance belongs to the actual training data sets or if it was generated artificially (see 410). The GAN generator 404 is configured to create new images that are passed to the GAN discriminator 408 and the GAN generator 404 is trained to generate images that fool the GAN discriminator 408 into determining that an artificial new data instance belongs to the actual training data.

In an embodiment, the GAN generator 404 receives an RGB image 402 and returns a depth map 406 based on the RGB image 402. The depth map 406 is fed to the GAN discriminator 408 alongside a stream of camera images from an actual dataset, and the GAN discriminator 408 determines a prediction of authenticity for each image, i.e. whether the image is a camera image from the actual dataset or a depth map 406 generated by the GAN generator 404. Thus, in such an embodiment, the GAN includes a double feedback loop wherein the GAN discriminator 408 is in a feedback loop with the ground truth of the images and the GAN generator 404 is in a feedback loop with the GAN discriminator 408. In an embodiment, the GAN discriminator 408 is a convolutional neural network configured to categorize images fed to it and the GAN generator 404 is an inverse convolutional neural network. In an embodiment, both the GAN generator 404 and the GAN discriminator 408 are seeking to optimize a different and opposing objective function or loss function. Thus, as the GAN generator 404 changes its behavior, so does the GAN discriminator 408, and vice versa. The losses of the GAN generator 404 and the GAN discriminator 408 push against each other to improve the outputs of the GAN.

In an embodiment, the GAN generator 404 is pretrained offline before the GAN generator 404 receives an RGB image 402 from a monocular camera. In an embodiment, the GAN discriminator 408 is pretrained before the GAN generator 404 is trained and this may provide a clearer gradient. In an embodiment, the GAN generator 404 is trained using a known dataset as the initial training data for the GAN discriminator 408. The GAN generator 404 may be seeded with a randomized input that is sampled from a predefined latent space, and thereafter, samples synthesized by the GAN generator 404 are evaluated by the GAN discriminator 408.

In an embodiment, the GAN generator 404 circumvents the bottleneck for information commonly found in an encoder-decoder network known in the art. In such an embodiment, the GAN generator 404 includes skip connections between each layer of the GAN generator 404, wherein each skip connection concatenates all channels of the GAN generator 404. In an embodiment, the GAN generator 404 is optimized by alternating between one gradient descent step on the adversarial network then one step on the GAN generator 404. At interference time, the generator net is run in the same manner as during the training phase. In an embodiment, instance normalization is applied to the GAN generator 404, wherein dropout is applied at test time and batch normalization is applied using statistics of the test batch rather than aggregated statistics of the training batch.

In an embodiment, the GAN comprises an encoder-decoder architecture as illustrated in FIG. 4. In such an embodiment, the GAN generator 404 receives the RGB image 402 and generates the depth map 406. The GAN discriminator 408 distinguishes between a pair comprising an RGB image 402 and a depth map 406. The GAN generator 404 and the GAN discriminator 408 are trained alternatively until the GAN discriminator 408 cannot tell the difference between an RGB image 402 and a depth map 406. This can encourage the GAN generator 404 to generate depth maps that are as close to ground truth as possible.

The depth map 406 constitute image-to-image translation that is carried out by the GAN generator 404 and based on the RGB image 402. In generating the depth map 406, the GAN generator 404 learns a mapping from a random noise vector z to determine the depth map 406 output image. The GAN generator 404 is trained to produce outputs that cannot be distinguished from real images by an adversarial GAN discriminator 408. In an embodiment, an adversarial GAN discriminator 408 learns to classify between an RGB image 402 and a depth map 406, and the GAN generator 404 is trained to fool the adversarial GAN discriminator 408. In such an embodiment, both the adversarial GAN discriminator 408 and the GAN generator 404 observe the depth map 406 output images.

In an embodiment, the input images, i.e. the RGB image 402 and the output images, i.e. the depth map 406 differ in surface appearance but both include a rendering of the same underlying structure. Thus, structure in the RGB image 402 is roughly aligned with structure in the depth map 406. In an embodiment, the GAN generator 404 architecture is designed around this consideration.

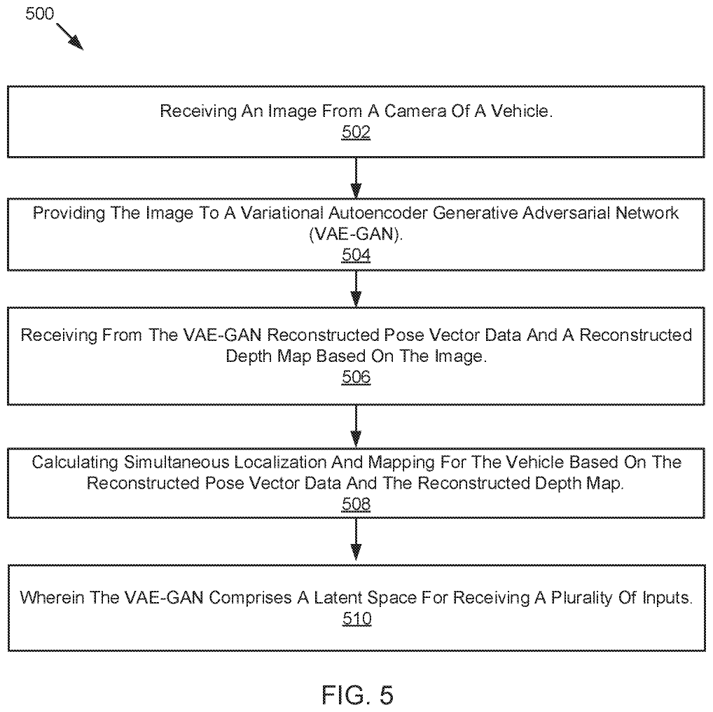

FIG. 5 illustrates a schematic flow chart diagram of a method 500 for localizing a vehicle in an environment and mapping the environment of the vehicle. The method 500 may be performed by any suitable computing device, including for example a vehicle controller such as an autonomous driving/assistance system 102. The method 500 begins and the computing device receives an image from a camera of a vehicle at 502. The computing device provides the image to a variational autoencoder generative adversarial network (VAE-GAN) at 504. The computing device receives from the VAE-GAN reconstructed pose vector data and a reconstructed depth map based on the image at 506. The computing device calculates simultaneous localization and mapping for the vehicle based on the reconstructed pose vector data and the reconstructed depth map at 508. The VAE-GAN is such that the VAE-GAN comprises a latent space for receiving a plurality of inputs (see 510).

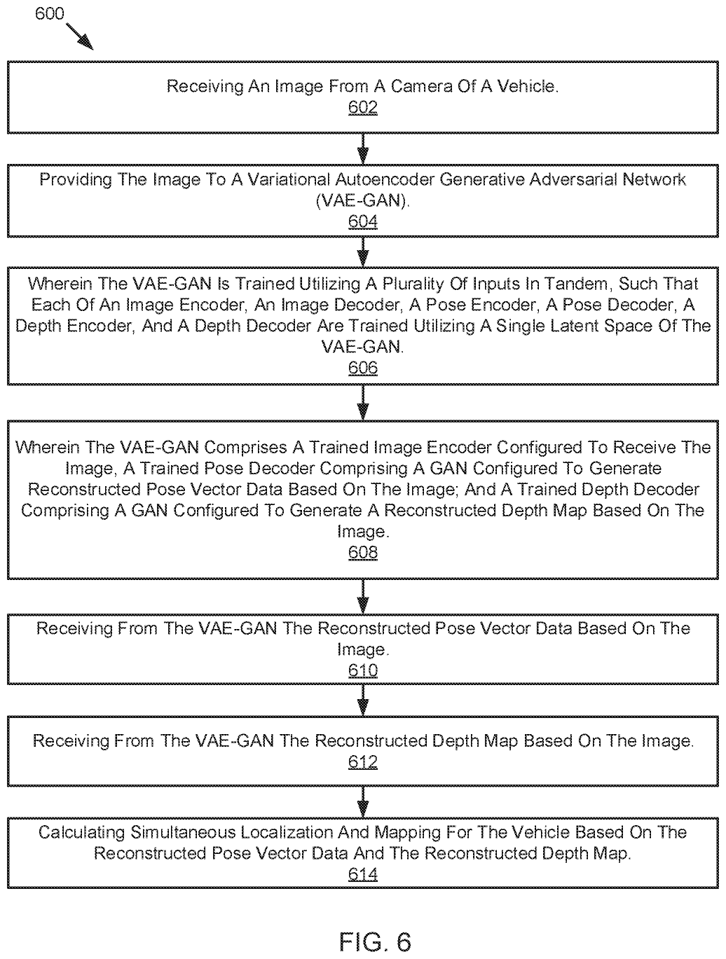

FIG. 6 illustrates a schematic flow chart diagram of a method 600 for localizing a vehicle in an environment and mapping the environment of the vehicle. The method 100 may be performed by any suitable computing device, including for example a vehicle controller such as an autonomous driving/assistance system 102. The method 600 begins and the computing device receives an image from a camera of a vehicle at 602. The computing devices provides the image to a variational autoencoder generative adversarial network (VAE-GAN) at 604. The VAE-GAN is such that the VAE-GAN is trained utilizing a plurality of inputs in tandem, such that each of an image encoder, an image decoder, a pose encoder, a pose decoder, a depth encoder, and a depth decoder are trained utilizing a single latent space of the VAE-GAN (see 606). The VAE-GAN is such that the VEA-GAN comprises a trained image encoder configured to receive the image, a trained pose decoder comprising a GAN configured to generate reconstructed pose vector data based on the image, and a trained depth decoder comprising a GAN configured to generate a reconstructed depth map based on the image (see 608). The computing device receives from the VAE-GAN the reconstructed pose vector data based on the image at 610. The computing device receives from the VAE-GAN the reconstructed depth map based on the image at 612. The computing device calculates simultaneous localization and mapping for the vehicle based on the reconstructed pose vector data and the reconstructed depth map at 614.

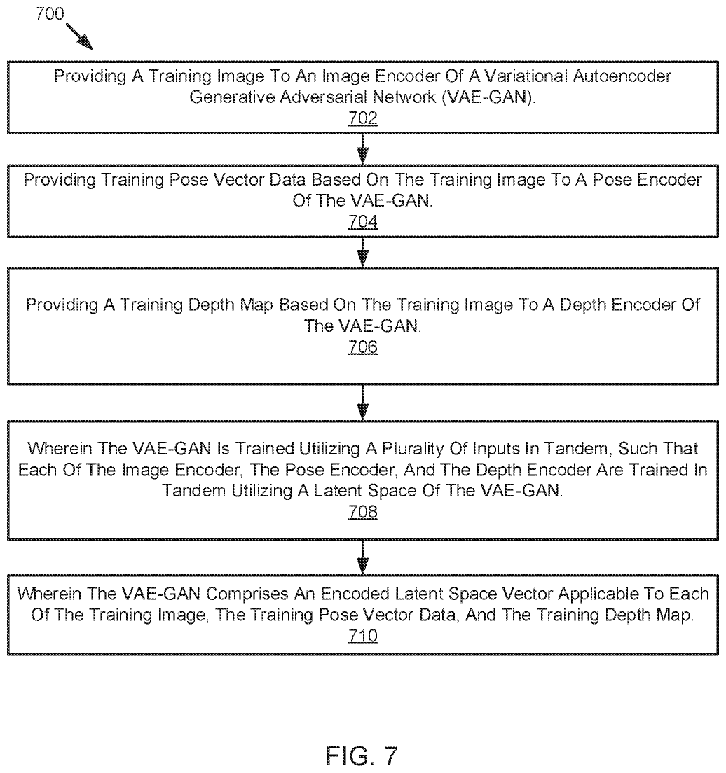

FIG. 7 illustrates a schematic flow chart diagram of a method 700 for training a VAE-GAN. The method 700 may be performed by any suitable computing device, including for example a vehicle controller such as an autonomous driving/assistance system 102. The method 700 begins and the computing device provides a training image to an image encoder of a variational autoencoder generative adversarial network (VAE-GAN) at 702. The computing device provides training pose vector data based on the training image to a pose encoder of the VAE-GAN at 704. The computing devices provides a training depth map based on the training image to a depth encoder of the VAE-GAN at 706. The VAE-GAN is such that the VAE-GAN is trained utilizing a plurality of inputs in tandem, such that each of the image encoder, the pose encoder, and the depth encoder are trained in tandem utilizing a latent space of the VAE-GAN (see 708). The VAE-GAN is such that the VAE-GAN comprises an encoded latent space vector applicable to each of the training image, the training pose vector data, and the training depth map (see 710).

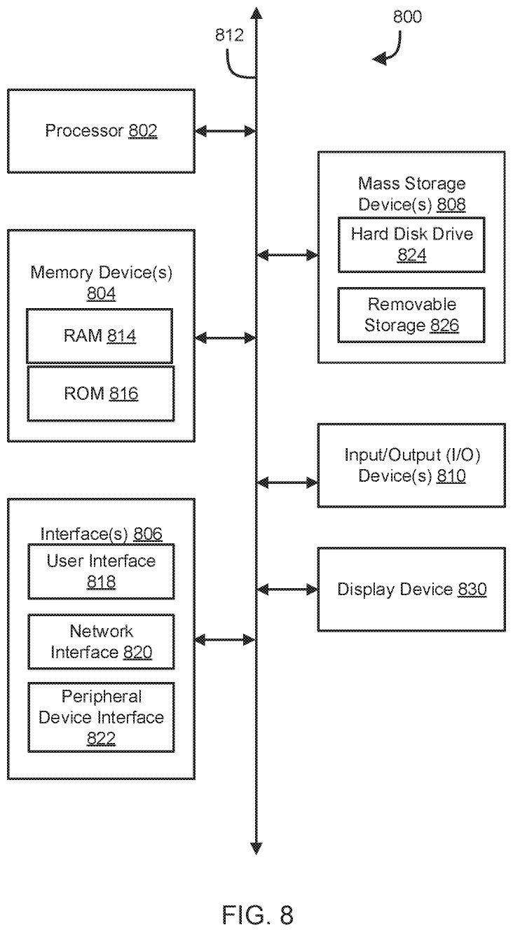

Referring now to FIG. 8, a block diagram of an example computing device 800 is illustrated. Computing device 800 may be used to perform various procedures, such as those discussed herein. In one embodiment, the computing device 800 can function as a neural network such as a GAN generator 404, a vehicle controller such as an autonomous driving/assistance system 102, a VAE-GAN 201, a server, and the like. Computing device 800 can perform various monitoring functions as discussed herein, and can execute one or more application programs, such as the application programs or functionality described herein. Computing device 800 can be any of a wide variety of computing devices, such as a desktop computer, in-dash computer, vehicle control system, a notebook computer, a server computer, a handheld computer, tablet computer and the like.

Computing device 800 includes one or more processor(s) 802, one or more memory device(s) 804, one or more interface(s) 806, one or more mass storage device(s) 808, one or more Input/output (I/O) device(s) 810, and a display device 830 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM) 814) and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid-state memory (e.g., Flash memory), and so forth. As shown in FIG. 8, a particular mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, or computing environments. Example interface(s) 806 may include any number of different network interfaces 820, such as interfaces to local area networks (LANs), wide area networks (WANs), wireless networks, and the Internet. Other interface(s) include user interface 818 and peripheral device interface 822. The interface(s) 806 may also include one or more user interface elements 818. The interface(s) 806 may also include one or more peripheral interfaces such as interfaces for printers, pointing devices (mice, track pad, or any suitable user interface now known to those of ordinary skill in the field, or later discovered), keyboards, and the like.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 800 and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is a method for simultaneous localization and mapping of a robot in an environment. The method includes: receiving an image from a camera of a vehicle; providing the image to a variational autoencoder generative adversarial network (VAE-GAN); receiving from the VAE-GAN reconstructed pose vector data and a reconstructed depth map based on the image; and calculating simultaneous localization and mapping for the vehicle based on the reconstructed pose vector data and the reconstructed depth map; wherein the VAE-GAN comprises a latent space for receiving a plurality of inputs.

Example 2 is a method as in Example 1, further comprising training the VAE-GAN, wherein training the VAE-GAN comprises: providing a training image to an image encoder of the VAE-GAN, wherein the image encoder is configured to map the training image to a compressed latent representation; providing training pose vector data based on the training image to a pose encoder of the VAE-GAN, wherein the pose encoder is configured to map the training pose vector data to the compressed latent representation; and providing a training depth map based on the training image to a depth encoder of the VAE-GAN, wherein the depth encoder is configured to map the training depth map to the compressed latent representation.

Example 3 is a method as in any of Examples 1-2, wherein the VAE-GAN is trained utilizing a plurality of inputs in tandem, such that each of: the image encoder and the image decoder; the pose encoder and the pose decoder; and the depth encoder and the depth decoder are trained in tandem utilizing the latent space of the VAE-GAN.

Example 4 is a method as in any of Examples 1-3, wherein each of the training image, the training pose vector data, and the training depth map share the latent space of the VAE-GAN.

Example 5 is a method as in any of Examples 1-4, wherein the VAE-GAN comprises an encoded latent space vector that is applicable to each of the training image, the training pose vector data, and the training depth map.

Example 6 is a method as in any of Examples 1-5, further comprising determining the training pose vector data based on the training image, wherein determining the training pose vector data comprises: receiving a plurality of stereo images forming a stereo image sequence; and calculating six Degree of Freedom pose vector data for successive images of the stereo image sequence using stereo visual odometry; wherein the training image provided to the VAE-GAN comprises a single image of a stereo image pair of the stereo image sequence.

Example 7 is a method as in any of Examples 1-6, wherein the camera of the vehicle comprises a monocular camera configured to capture a sequence of images of an environment of the vehicle, and wherein the image comprises a red-green-blue (RGB) image.

Example 8 is a method as in any of Examples 1-7, wherein the VAE-GAN comprises an encoder opposite to a decoder, and wherein the decoder comprises a generative adversarial network (GAN) configured to generate an output, wherein the GAN comprises a GAN generator and a GAN discriminator.

Example 9 is a method as in any of Examples 1-8, wherein the VAE-GAN comprises: a trained image encoder configured to receive the image; a trained pose decoder comprising a GAN configured to generate the reconstructed pose vector data based on the image; and a trained depth decoder comprising a GAN configured to generate the reconstructed depth map based on the image.

Example 10 is a method as in any of Examples 1-9, wherein the VAE-GAN comprises: an image encoder configured to map the image to a compressed latent representation; a pose decoder comprising a GAN generator adversarial to a GAN discriminator; a depth decoder comprising a GAN generator adversarial to a GAN discriminator; and a latent space, wherein the late space is common to each of the image encoder, the pose decoder, and the depth decoder.

Example 11 is a method as in any of Examples 1-10, wherein the latent space of the VAE-GAN comprises an encoded latent space vector utilized for each of the image encoder, the pose decoder, and the depth decoder.

Example 12 is a method as in any of Examples 1-11, wherein the reconstructed pose vector data comprises six Degree of Freedom pose data pertaining to the camera of the vehicle.

Example 13 is non-transitory computer-readable storage media storing instructions that, when executed by one or more processors, cause the one or more processors to: receive an image from a camera of a vehicle; provide the image to a variational autoencoder generative adversarial network (VAE-GAN); receive from the VAE-GAN reconstructed pose vector data and a reconstructed depth map based on the image; and calculate simultaneous localization and mapping for the vehicle based on the reconstructed pose vector data and the reconstructed depth map; wherein the VAE-GAN comprises a latent space for receiving a plurality of inputs.

Example 14 is non-transitory computer-readable storage media as in Example 13, wherein the instructions further cause the one or more processors to train the VAE-GAN, wherein training the VAE-GAN comprises: providing a training image to an image encoder of the VAE-GAN, wherein the image encoder is configured to map the training image to a compressed latent representation; providing training pose vector data based on the training image to a pose encoder of the VAE-GAN, wherein the pose encoder is configured to map the training pose vector data to the compressed latent representation; and providing a training depth map based on the training image to a depth encoder of the VAE-GAN, wherein the depth encoder is configured to map the training depth map to the compressed latent representation.

Example 15 is non-transitory computer-readable storage media as in any of Examples 13-14, wherein the instructions cause the one or more processors to train the VAE-GAN utilizing a plurality of inputs in tandem, such that each of: the image encoder and the image decoder; the pose encoder and the pose decoder; and the depth encoder and the depth decoder are trained in tandem such that each of the training image, the training pose vector data, and the training depth map share the latent space of the VAE-GAN.

Example 16 is non-transitory computer-readable storage media as in any of Examples 13-15, the instructions further cause the one or more processors to calculate the training pose vector data based on the training image, wherein calculating the training pose vector data comprises: receiving a plurality of stereo images forming a stereo image sequence; and calculating six Degree of Freedom pose vector data for successive images of the stereo image sequence using stereo visual odometry; wherein the training image provided to the VAE-GAN comprises a single image of a stereo image pair of the stereo image sequence.

Example 17 is non-transitory computer-readable storage media as in any of Examples 13-16, wherein the VAE-GAN comprises an encoder opposite to a decoder, and wherein the decoder comprises a generative adversarial network (GAN) configured to generate an output, wherein the GAN comprises a GAN generator and a GAN discriminator.

Example 18 is a system for simultaneous localization and mapping of a vehicle in an environment, the system comprising: a monocular camera of a vehicle; a vehicle controller in communication with the monocular camera, wherein the vehicle controller comprises non-transitory computer readable storage media storing instructions that, when executed by one or more processors, cause the one or more processors to: receive an image from the monocular camera of the vehicle; provide the image to a variational autoencoder generative adversarial network (VAE-GAN); receive from the VAE-GAN reconstructed pose vector data based on the image; receive from the VAE-GAN a reconstructed depth map based on the image; and calculate simultaneous localization and mapping for the vehicle based on one or more of the reconstructed pose vector data and the reconstructed depth map; wherein the VAE-GAN comprises a latent space for receiving a plurality of inputs.

Example 19 is a system as in Example 18, wherein the VAE-GAN comprises: an image encoder configured to map the image to a compressed latent representation; a pose decoder comprising a GAN generator adversarial to a GAN discriminator; a depth decoder comprising a GAN generator adversarial to a GAN discriminator; and a latent space, wherein the late space is common to each of the image encoder, the pose decoder, and the depth decoder.

Example 20 is a system as in any of Examples 18-19, wherein the VAE-GAN comprises: an image encoder configured to map the image to a compressed latent representation; a pose decoder comprising a GAN generator adversarial to a GAN discriminator; a depth decoder comprising a GAN generator adversarial to a GAN discriminator; and a latent space, wherein the late space is common to each of the image encoder, the pose decoder, and the depth decoder.

Example 21 is a system or device that includes means for implementing a method, system, or device as in any of Examples 1-20.

In the above disclosure, reference has been made to the accompanying drawings, which form a part hereof, and in which is shown by way of illustration specific implementations in which the disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein purposes of illustration and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method comprising:
receiving an image from a camera of a vehicle;
providing the image to a variational autoencoder generative adversarial network (VAE-GAN);
receiving from the VAE-GAN reconstructed pose vector data and a reconstructed depth map based on the image; and
calculating simultaneous localization and mapping for the vehicle based on the reconstructed pose vector data and the reconstructed depth map;
wherein the VAE-GAN comprises a latent space for receiving a plurality of inputs.

2. The method of claim 1, further comprising training the VAE-GAN, wherein training the VAE-GAN comprises:
providing a training image to an image encoder of the VAE-GAN, wherein the image encoder is configured to map the training image to a compressed latent representation of the training image;
providing training pose vector data based on the training image to a pose encoder of the VAE-GAN, wherein the pose encoder is configured to map the training pose vector data to a compressed latent representation of the training pose vector data; and
providing a training depth map based on the training image to a depth encoder of the VAE-GAN, wherein the depth encoder is configured to map the training depth map to a compressed latent representation of the training depth map.

3. The method of claim 2, wherein the VAE-GAN is trained utilizing a plurality of inputs in tandem, such that each of:
the image encoder and a corresponding image decoder;
the pose encoder and a corresponding pose decoder; and
the depth encoder and a corresponding depth decoder are trained in tandem utilizing the latent space of the VAE-GAN.

4. The method of claim 2, wherein each of the training image, the training pose vector data, and the training depth map share the latent space of the VAE-GAN.

5. The method of claim 2, wherein the VAE-GAN comprises an encoded latent space vector that is applicable to each of the training image, the training pose vector data, and the training depth map.

6. The method of claim 2, further comprising determining the training pose vector data based on the training image, wherein determining the training pose vector data comprises:
receiving a plurality of stereo images forming a stereo image sequence; and
calculating six Degree of Freedom pose vector data for successive images of the stereo image sequence using stereo visual odometry;
wherein the training image provided to the VAE-GAN comprises a single image of a stereo image pair of the stereo image sequence.

7. The method of claim 1, wherein the camera of the vehicle comprises a monocular camera configured to capture a sequence of images of an environment of the vehicle, and wherein the image comprises a red-green-blue (RGB) image.

8. The method of claim 1, wherein the VAE-GAN comprises an encoder opposite to a decoder, and wherein the decoder comprises a generative adversarial network (GAN) configured to generate an output, wherein the GAN comprises a GAN generator and a GAN discriminator.

9. The method of claim 1, wherein the VAE-GAN comprises:
a trained image encoder configured to receive the image;
a trained pose decoder comprising a GAN configured to generate the reconstructed pose vector data based on the image; and
a trained depth decoder comprising a GAN configured to generate the reconstructed depth map based on the image.

10. The method of claim 1, wherein the VAE-GAN comprises:
an image encoder configured to map the image to a compressed latent representation;
a pose decoder comprising a GAN generator adversarial to a GAN discriminator;
a depth decoder comprising a GAN generator adversarial to a GAN discriminator; and
a latent space, wherein the late space is common to each of the image encoder, the pose decoder, and the depth decoder.

11. The method of claim 10, wherein the latent space of the VAE-GAN comprises an encoded latent space vector utilized for each of the image encoder, the pose decoder, and the depth decoder.

12. The method of claim 1, wherein the reconstructed pose vector data comprises six Degree of Freedom pose data pertaining to the camera of the vehicle.

13. Non-transitory computer-readable storage media storing instructions that, when executed by one or more processors, cause the one or more processors to:
receive an image from a camera of a vehicle;
provide the image to a variational autoencoder generative adversarial network (VAE-GAN);
receive from the VAE-GAN reconstructed pose vector data and a reconstructed depth map based on the image; and
calculate simultaneous localization and mapping for the vehicle based on the reconstructed pose vector data and the reconstructed depth map;
wherein the VAE-GAN comprises a latent space for receiving a plurality of inputs.

14. The non-transitory computer-readable storage media of claim 13, wherein the instructions further cause the one or more processors to train the VAE-GAN, wherein training the VAE-GAN comprises:
providing a training image to an image encoder of the VAE-GAN, wherein the image encoder is configured to map the training image to a compressed latent representation in the latent space;
providing training pose vector data based on the training image to a pose encoder of the VAE-GAN, wherein the pose encoder is configured to map the training pose vector data to a compressed latent representation in the latent space; and
providing a training depth map based on the training image to a depth encoder of the VAE-GAN, wherein the depth encoder is configured to map the training depth map to a compressed latent representation in the latent space.

15. The non-transitory computer-readable storage media of claim 14, wherein the instructions cause the one or more processors to train the VAE-GAN utilizing a plurality of inputs in tandem, such that each of:
the image encoder and a corresponding image decoder;
the pose encoder and a corresponding pose decoder; and
the depth encoder and a corresponding depth decoder are trained in tandem such that each of the training image, the training pose vector data, and the training depth map share the latent space of the VAE-GAN.

16. The non-transitory computer-readable storage media of claim 14, wherein the instructions further cause the one or more processors to calculate the training pose vector data based on the training image, wherein calculating the training pose vector data comprises:
receiving a plurality of stereo images forming a stereo image sequence; and
calculating six Degree of Freedom pose vector data for successive images of the stereo image sequence using stereo visual odometry;
wherein the training image provided to the VAE-GAN comprises a single image of a stereo image pair of the stereo image sequence.

17. The non-transitory computer-readable storage media of claim 13, wherein the VAE-GAN comprises an encoder opposite to a decoder, and wherein the decoder comprises a generative adversarial network (GAN) configured to generate an output, wherein the GAN comprises a GAN generator and a GAN discriminator.

18. A system for simultaneous localization and mapping of a vehicle in an environment, the system comprising:
a monocular camera of a vehicle;
a vehicle controller in communication with the monocular camera, wherein the vehicle controller comprises non-transitory computer readable storage media storing instructions that, when executed by one or more processors, cause the one or more processors to:
receive an image from the monocular camera of the vehicle;
provide the image to a variational autoencoder generative adversarial network (VAE-GAN);
receive from the VAE-GAN reconstructed pose vector data based on the image;
receive from the VAE-GAN a reconstructed depth map based on the image; and
calculate simultaneous localization and mapping for the vehicle based on one or more of the reconstructed pose vector data and the reconstructed depth map;
wherein the VAE-GAN comprises a latent space for receiving a plurality of inputs.

19. The system of claim 18, wherein the VAE-GAN is trained and training the VAE-GAN comprises:
providing a training image to an image encoder of the VAE-GAN, wherein the image encoder is configured to map the training image to a compressed latent representation of the training image;
providing training pose vector data based on the training image to a pose encoder of the VAE-GAN, wherein the pose encoder is configured to map the training pose vector data to a compressed latent representation of the training pose vector data; and
providing a training depth map based on the training image to a depth encoder of the VAE-GAN, wherein the depth encoder is configured to map the training depth map to a compressed latent representation of the training depth map.

20. The system of claim 18, wherein the VAE-GAN comprises:
an image encoder configured to map the image to a compressed latent representation;
a pose decoder comprising a GAN generator adversarial to a GAN discriminator;
a depth decoder comprising a GAN generator adversarial to a GAN discriminator; and
a latent space, wherein the late space is common to each of the image encoder, the pose decoder, and the depth decoder.
